(19) United States
(12) Patent Application Publication
(10) Pub. No.: US 2014/0211686 A1
(43) Pub. Date: Jul. 31, 2014

(54) A CHANNEL SELECTION METHOD, AND CORRESPONDING WIFI DEVICE AND COMPUTER PROGRAM

(71) Applicants: Laurent Cariou, Rennes (FR); David Bernard, Marcille Raoul (FR)

(72) Inventors: Laurent Cariou, Rennes (FR); David Bernard, Marcille Raoul (FR)

(73) Assignee: ORANGE, Paris (FR)

(21) Appl. No.: 14/342,496

(22) PCT Filed: Aug. 31, 2012
(86) PCT No.: PCT/FR2012/051962

§ 371 Date: Mar. 3, 2014

(30) Foreign Application Priority Data
Sep. 2, 2011 (FR) 1157812

(51) Int. Cl. H04W 72/04; H04W 4/06

(52) U.S. Cl. CPC H04W 72/0426; H04W 4/06
USPC 370/312; 370/329

(57) ABSTRACT

A method is provided for selecting a channel for a multiband WiFi access network with channel sharing between access points of the WiFi network. A first band is said to be a “transmission” band and a second band is said to be a “signaling” band, which has radio coverage that is greater than that of the transmission band. The method includes transmitting first pertinent information in the signaling band, the first pertinent information relating to occupancy of the transmission band by the access point; and receiving second pertinent information in the signaling band, the second pertinent information relating to occupancy of the transmission band by neighboring access points, these steps taking place simultaneously with any step of transmission in the transmission band.

### CROSS-REFERENCE TO RELATED APPLICATIONS

This Application is a Section 371 National Stage Application of International Application No. PCT/FR2012/051962, filed Aug. 31, 2012, which is incorporated by reference in its entirety and published as WO 2013/030514 on Mar. 7, 2013, not in English.

### FIELD OF THE INVENTION

The present invention relates to the field of telecommunications. Within this field, the invention relates more particularly to the field of communication by radio, also known as wireless communication, and it includes WiFi networks as standardized by standards numbers 802.11 et seq. from the Institute of Electrical and Electronic Engineers (IEEE). Those standards guarantee interoperability between wireless communications devices that comply with the standards.

Below in this document, the term “WiFi” should be understood as covering the entire field of communications by radio.

The invention is described in a context of a WiFi network of infrastructure in which a plurality of access points cohabit and enable stations to set up communications, e.g. with a terminal or with a remote server.

More precisely, the invention relates to the frequency occupancy of radio bands dedicated to WiFi devices, in particular the band around 5 gigahertz (GHz) as defined in the IEEE802.11n standard and the band around 868.68 megahertz (MHz) as defined in the IEEE802.11ah standard, and it relates more particularly to a mechanism for selecting a radio channel from the various radio channels that can be used in a WiFi system when the WiFi devices are fitted with multiple radio interfaces enabling them to send data or signaling frames over at least two different frequency bands. The radio channels of such devices are said to be multiband channels.

The term “WiFi device” is used herein to mean apparatus constituting a basic service set (BSS) and constituted by an access point and the stations associated with the access point, i.e. the stations situated in the radio coverage zone of the access point. The invention lies in a context in which the devices may belong to different BSSs.

### PRIOR ART

When a WiFi device has data for transmission, it needs to access the transmission channel. Given that the WiFi device is multiband and that each band generally has a plurality of channels, access to the transmission channel requires the channel selected beforehand. Existing channel selection mechanisms correspond either to a centralized mode or to a decentralized mode.

In the centralized mode, a controller forces each access point to select a channel as a function of a well-defined frequency plan.

In the decentralized mode, a WiFi access point selects a channel as a function of pertinent information available to it, such as the occupancy rate of the channel, and the noise level. In order to have pertinent information available for making the selection, the access point may:
perform a passive scan by listening to transmissions or perform an active scan (i.e. “probe request/response”) by exchanging frames over the entire band for all of the transmission channels in order to find out the occupancy of a channel in the various scanned channels. This occupancy information may be obtained by a long-duration mechanism using the clear channel assessment (CCA) measurement, which makes it possible to calculate the time during which the channel is occupied and the time during which the channel is free. Nevertheless, this measurement can be disturbed by devices that are hidden, i.e. stations or access points that can transmit without being “heard” by other stations or other access points. With reference to FIG. 1, when two stations STA1 and STA2 are on opposite sides of an access point AP and far enough apart from each other to be incapable of detecting a transmission coming from the other station, those stations are said to be mutually “hidden”. Under such circumstances, the station STA1, or the station STA2, considers the channel as being free and accesses the channel even though the hidden station STA2, or STA1 as the case may be, may be occupying that channel; or
decode only the “beacon” sent by the neighboring access points in which the BSS load information as defined in the IEEE802.11k standard is transmitted, this load information specifying the occupancy of the transmission channel for the channels concerned. This information may also be disturbed by hidden devices.

Recovering pertinent information for selecting a channel using the above-described known methods requires at least one transmission channel to be scanned other than the current transmission channel in use by the access point. Consequently, the access point must stop listening or transmitting over its current active channel in order to switch channel before being able to carry out the scan. Such a constraint can be penalizing, in particular when channel selection is needed in order to mitigate traffic overload.

### SUMMARY OF THE INVENTION

The invention provides an advantageous novel solution in the form of a channel selection method for a WiFi network with multiband channel sharing between devices, a first band being a “transmission” band and a second band being a “signaling” band with radio coverage that is greater than that of the transmission band, which method is more effective than known methods.

Thus, the invention provides a method of selecting a channel for a multiband WiFi device in a WiFi network with multiband channel sharing between devices of the WiFi network, a first band being a “transmission” band, and a second band being a “signaling” band and having radio coverage that is greater than the transmission band. The method comprises:
a step of transmitting first pertinent information in the signaling band, the information relating to the occupancy of the transmission band by the device; and
a step of receiving second pertinent information in the signaling band, the information relating to the occupancy of the transmission band by neighboring devices, these steps taking place simultaneously with any step of transmission in the transmission band.

Since the signaling band is common to the various WiFi devices, access points, WiFi network stations, each device can thus recover the pertinent information associated with the occupancy of the transmission band by the WiFi devices that are nearby without needing to interrupt a transmission taking place in the transmission band. The fact that the coverage of the signaling band is greater than the coverage of the transmission band makes it possible to solve problems of devices associated with the transmission band being hidden, or at least makes it possible to significantly reduce the number of devices that are hidden, depending on the signaling band selected relative to the transmission band.

Typically, the multiband WiFi network is such that a first band presents better characteristics for data transmission (better data rate, . . . ), while a second band presents better characteristics for range (at low data rate, . . . ). The first band is then considered as being the data transmission band and the second band as being the signaling band.

For example, the WiFi network is a WiFi access network with a transmission band corresponding to a 5 GHz band with reference to a network in compliance with the IEEE802.11n standard and with a signaling band that corresponds to an 868 MHz to 868.6 MHz band with reference to a network in compliance with the IEEE802.11ah standard. The WiFi network has at least two multiband access points AP (5 GHz band+868 MHz band) and one or more stations. The IEEE802.11ad standard defines a multiband mode which is applicable to all WiFi systems (11a, b, g, n, ac, ad, af, ah, . . . ) even if its definition in that standard involves only specific bands. Given the differences in the center frequencies of the transmission band and of the signaling band, the coverage of the signaling band is considerably greater than that of the transmission band. For broadcasting pertinent information within the WiFi access network, the multiband access points of the WiFi network share a common signaling channel when the signaling band has a plurality of channels.

The pertinent information about the occupancy of the transmission band by a WiFi device may provide the identities of the channels used by the WiFi device in the transmission band, for example.

By way of example, the IEEE802.11n and IEEE802.11ac standards make provision for multichannel transmission as follows: two channels for transmission at 40 MHz, four channels for transmission at 80 MHz, eight channels for transmission at 80+80 MHz or at 160 MHz. Alternatively or additionally, the pertinent information may relate to the load or the occupancy of the channel(s) in the transmission band by the access point and possibly by the stations with which it is in communication. Channel occupancy is often determined by calculating the ratio between the time used for transmission and the time during which the channel is free (duty cycle). Several metrics are defined in the IEEE802.11 standards: “BSS load” (IEEE802.11n) which corresponds to the above definition; “Qload” (IEEE802.11aa) which adds more precise information about the types of traffic on the channel; and “extended BSS load” (IEEE802.11ac) which extends the definition by taking account of multiuser-multiple input multiple output (MU-MIMO) transmission corresponding to the possibility of transmitting simultaneously to a plurality of users in a system having a plurality of transmit antennas, and taking account of the transmission modes at 40 MHz, 80 MHz, 80+80 MHz, and 160 MHz. For each of those modes, there exists a metric that makes it possible to calculate the occupancy of the channel in each of the channels used by the access point.

Alternatively or additionally, the pertinent information may be associated with the bandwidth requirements of the device.

For example, the information may be associated with the equivalent bandwidth, i.e. the theoretical bandwidth available to the device for 100% of the time.

The pertinent information may also be associated with localization information, or with information about other devices in sight, i.e. within the radio coverage of the device in question. Under such circumstances in particular, when neighboring devices, access points, stations, do not possesses multiband functionality and cannot transmit pertinent information in the signaling band, the pertinent information may be associated with the channels used by those devices and with their loads. Under such circumstances, this information must be obtained by scanning in the data transmission band.

The first and second pertinent information may be associated with information of the same kind or with information of different kinds.

Thus, a given device together with the neighboring device, i.e. located in the same coverage zone of the signaling band, use a channel in the transmission band that is determined by each device performing a channel selection method of the invention. The devices need not be on the same channel in the data transmission band and may be capable of receiving pertinent information about other devices via the common signaling band. The devices having knowledge of information about the occupancy of the transmission band advantageously makes it possible to take this occupancy into account during channel selection of the invention, thus making it possible to limit the sharing of the channel between neighboring devices.

In an implementation of the invention, the first pertinent information is transmitted in a broadcast mode.

Broadcast mode is advantageous in that it does not require any signaling to be exchanged between the devices in order to obtain occupancy information about the transmission channel.

In an implementation of the invention, the pertinent information is encapsulated in a frame having fields filled in for the purpose of transferring a session from a first channel to a second channel of the multiband WiFi network.

The first channel is different from the second channel. The first and second channels may belong to subbands that are contiguous or disjoint in the transmission band.

This implementation is more particularly adapted to WiFi networks complying with the IEEE802.11ad standard in which a multiband mode is defined. Nevertheless, this mode is applicable with all WiFi systems (IEEE802.11a, b, g, n, ac, ad, af, ah, . . . ) even if the mode is defined in a particular frequency band. This mode is used when a device possesses two WiFi interfaces operating in two different bands. The provisional text of the IEEE802.11ad standard specifies the multiband element that can be transmitted in the beacons, in the associations request/response frames, or in the probe request/response frames. The multiband element broadcasts the capabilities of the devices possessing the multiband function. In the IEEE802.11ad standard, this element is broadcast in one of the transmission bands and indicates the existence of the other transmission band. In particular, the band ID field makes it possible to define which other band is involved, and the multiband STA capability field defines the role played by the device in that other band (access point AP, station STA, etc.). The multiband element serves in particular for a fast session transfer of the first channel to the second channel when the first band is no longer conveying data in satisfactory manner, e.g. as a result of saturation. Enriching this element with pertinent information about the occupancy of the channels is particularly advantageous for avoiding selecting a channel that is already loaded or even at its saturation limit. In the invention, one of the bands is considered as the signaling band, and the element is broadcast over that band, with session transfer taking place between subbands of the transmission band.

In an implementation of the invention, the method further comprises:
a step of exchanging frames in the signaling band between the device and a neighboring device, the device transmitting a channel switch request frame and waiting for a frame in response coming from the neighboring device indicating that it accepts or rejects channel switching.

This implementation is particularly advantageous when enough free channels exist for the needs of the devices, but when these channels are disjoint even though the device needs channels that are adjacent. For example, the device might need 80 MHz contiguously while the pertinent information about occupancy indicates that two 40 MHz channels are free, but that they are disjoint.

In this implementation, the device launches a negotiation procedure with another device so that that other device switches channel to release a channel that is adjacent to a free channel.

The negotiation is performed by exchanging frames between the devices in the signaling band: specifically a channel switch request frame and a channel switch response frame.

The request frame may incorporate the following elements:
an identifier of the transmission band involved in the request;
an identifier of the device that is to benefit from the channel switch;
an identifier of the device transmitting the channel switch request (this identifier may differ from the preceding identifier when the beneficiary of the switch does not have multiband WiFi interfaces, and when the device transmitting the request is managing the switch on its behalf);
an index of free channels for the channel switch; and
an identifier of one or more channels to which the device receiving the request can switch while satisfying its own bandwidth requirements (assuming that these bandwidth requirements have been included in the multiband element).

The response frame may include the following elements:
an identifier of the transmission band involved in the request;
an identifier of the device that is to benefit from the channel switch:
an identifier of the device transmitting the channel switch request;
the acceptance or the rejection of the channel switch request;
in the event of acceptance, the indication of the destination channel; and
in the event of acceptance, the indication of the time that is to elapse before the channel switch.

The invention also provides a multiband WiFi device. The WiFi device is intended more particularly for a multiband WiFi access network having a plurality of multiband access points, a first band referred to as a “transmission band”, and a second band referred to as a “signaling band” and having coverage that is greater than that of the transmission band.

A WiFi device of the invention comprises:
transceiver means for transmitting and receiving data frames via a multiband channel of the transmission band;
transceiver means adapted to transmit and receive signaling frames in the signaling band, the signaling frames including pertinent information about the occupancy of the transmission band respectively by the device and by neighboring devices; and
the transceiver means respectively for the transmission band and for the signaling band being jointly adapted to transmit and receive simultaneously.

Such a WiFi device is adapted in particular for performing the channel selection method of the invention as described above. By way of example, it may be an access point or a WiFi station.

In an embodiment of the invention, the WiFi device is such that the transceiver means in the signaling band comprise broadcast means.

In a preferred implementation, the steps of the channel selection method of the invention are determined by program instructions in the form of one or more modules incorporated respectively in electronic circuits such as chips, themselves possibly being arranged in electronic equipment such as a WiFi device. The channel selection method of the invention may also be performed when the program (or its modules) are loaded into a calculator member such as a processor or the equivalent with its operation then being controlled by executing the program.

Consequently, the invention also applies to a computer program (or to its various modules), in particular a computer program on or in a data medium and adapted to perform the invention. The program may use any programming language, and may be in the form of source code, object code, or code intermediate between source code and object code, such as in a partially complied form, or in any other desirable form for implementing a method of the invention.

The data medium may be any entity or equipment capable of storing the program. For example, the medium may comprise storage means such as a random access memory (RAM), a read only memory (ROM), e.g. a compact disk (CD) ROM, or a microelectronic circuit ROM, or indeed magnetic recording means, e.g. a hard disk, or else an electrically programmable read only memory (EPROM) installed in a universal serial bus (USB) key.

Alternatively, the data medium may be an integrated circuit in which the program is incorporated, the circuit being adapted to execute or to be used in the execution of the method in question.

Furthermore, the program may be converted into a transmissible form such as an electrical or optical signal suitable for being conveyed via an electrical or optical cable, by radio, or by other means. The program of the invention may in particular be downloaded from a network of the Internet type.

Thus, the invention also provides a computer program on a data medium. The program includes program instructions adapted to perform a channel selection method in a multiband WiFi device for a multiband WiFi access network by using one of the methods of the invention, when said program is loaded in and executed by the WiFi device that is to perform the channel selection method.

The invention also provides a data medium including program instructions adapted to performing a channel selection method performed by a multiband WiFi device for a multiband WiFi access network by using a method of the invention when said program is loaded in and executed by the WiFi device in order to perform the channel selection method.

### LIST OF FIGURES

Other characteristics and advantages of the invention appear more clearly on reading the following description of particular embodiments given merely as illustrative and non-limiting examples, and with reference to the accompanying drawings, in which:

FIG. 1 is a diagram showing a basic service set (BSS) infrastructure of stations STA1, STA2 in a wireless radio system having an access point AP, the station STA2 being hidden from the station STA1, and this figure being described with reference to the prior art;

FIG. 2 is a diagram showing a multiband WiFi access network having eight access points and one terminal;

FIG. 3 is a flow chart showing the main steps of the channel selection method of the invention;

FIG. 4 is a plot along the frequency axis showing the rates at which the channels of the transmission band are occupied by the access points neighboring the access point AP;

FIG. 5 is a plot along the frequency axis showing the rates at which the channels of the transmission band are occupied by the access point neighboring the access point AP, with a window showing the channels selected by the access point AP when performing a method of the invention, and in the example shown the occupancy of the band is compatible with the access point's requirement for two free channels that are adjacent;

FIG. 6 is a plot along the frequency axis showing the rates at which the channels of the transmission band are occupied by the access point neighboring the access point AP, with a window showing the channels selected by the access point AP when performing a method of the invention, and in the example shown the occupancy of the band is not totally compatible with the need of the access point for four free channels that are adjacent;

FIG. 7 shows the performance of a negotiation between the access point AP and the access point AP2 to cause the access point AP2 to switch channel and release the channel that it is occupying and that is adjacent to the group of three free channels, after the access point AP has observed that the occupancy of the band is not compatible with its own requirements, as shown in FIG. 6; and

FIG. 8 is a diagram of an example of simplified structure for a WiFi device suitable for performing a channel selection method of the invention.

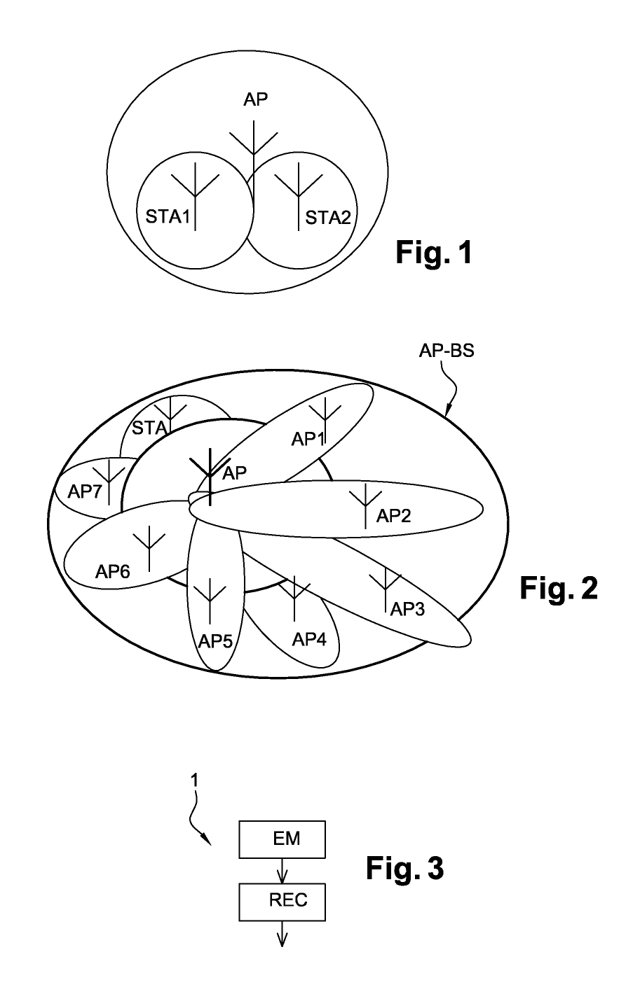

### DESCRIPTION OF AN IMPLEMENTATION OF THE INVENTION

The WiFi communications network under consideration and shown in FIG. 2 has nine WiFi devices, with at least eight of them, AP, AP1-AP7 performing in particular an access point function. These devices are referred to below as “access points”, AP, and they may correspond to gateways or to relays. The device STA is more particularly a terminal. The WiFi devices are fitted with multiple radio interfaces enabling them to transmit frames in at least two frequency bands.

The invention is described in the context of a WiFi network with a transmission band that corresponds to a 5 GHz band with reference to a network in compliance with the IEEE802.11n standard, and to a signaling band that corresponds to an 868 MHz to 868.6 MHz band with reference to a network in compliance with the IEEE802.11ah standard.

The invention involves broadcasting information in the signaling band between the WiFi devices (AP and STA) sharing the same transmission band in order to improve the occupancy of the radio spectrum in this band.

In the illustration of FIG. 2, the radio range of the signaling band BS from the access point AP covers all of the access points AP1-AP7 and also the terminal STA. All of the other more or less elliptical shapes represent the radio coverage in the transmission band of each of the devices.

The IEEE802.11ad standard defines a multiband mode that is applicable to all WiFi systems (11a, b, g, n, ac, ad, af, ah, . . . ) even if its definition in that standard involves only specific bands.

This mode is used when a device possesses two WiFi modules operating in two different bands.

FIG. 3 is a flow chart showing the main steps of the channel selection method of the invention as performed by the access point AP.

The method 1 comprises a step EM of transmitting first pertinent information over the signaling band and associated with the occupancy of the transmission band by the access point AP.

The method 1 has a step REC of receiving second pertinent information in the signaling band and relating to the occupancy of the transmission band by neighboring access points.

The transmission step EM and the reception step REC are performed together with any step of transmission by the access point AP in the transmission band.

In an implementation, the first pertinent information is transmitted in a broadcast mode by the access point AP.

In an implementation, the pertinent information is encapsulated in a frame having fields that are filled in for the purpose of transferring a session from a first channel to a second channel of the multiband WiFi network.

The original version of the IEEE802.11ad standard describes the “multiband element” as set out below in Table 1.

TABLE 1

| | Element | | Multiband | | Regulatory | Channel | | Beacon |
|---|---|---|---|---|---|---|---|---|
| | ID | Length | control | Band ID | class | number | BSSID | interval |
| Octets | 1 | 1 | 1 | 1 | 1 | 1 | 6 | 2 |

| | | | | | Pairwise | |
|---|---|---|---|---|---|---|
| | | | | | cipher | Pairwise |
| | | Multiband | FST | STA MAC | suite | cipher |
| | | STA | session | address | count | suite list |
| | TSF offset | capability | timeout | (optional) | (optional) | (optional) |
| Octets | 8 | 2 | 1 | 6 | 2 | 4*m |

This element gives indications about the capabilities of devices that possess the multiband function. On being broadcast in one of the bands, it serves to signal the existence of the other band and to identify it, in particular by means of the “band ID” field. The “multiband STA capability” field defines in particular the role played by that device in said other band: i.e. access point (AP) or terminal (STA). It may be transmitted using beacons, with association request/response frames, or with probe request/response frames.

In an implementation, the “multiband element” is enriched with pertinent information. This element is encapsulated in a frame that is broadcast by the access point AP, AP1-AP7 over the signaling band.

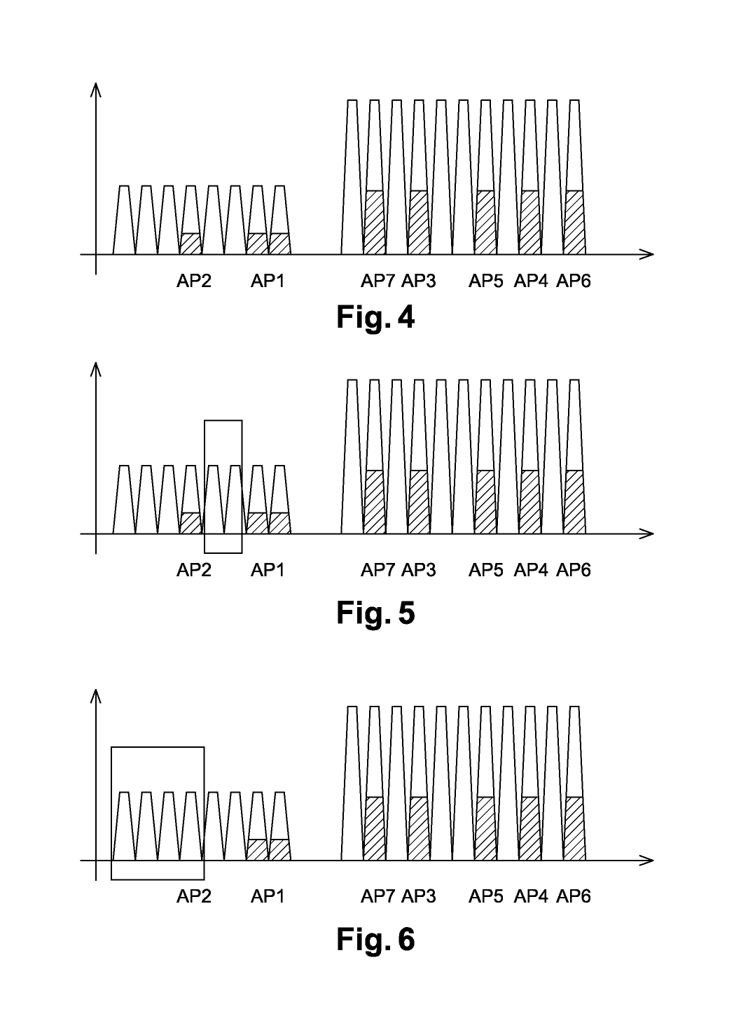

A particular implementation of a method of the invention is described below and shown in FIGS. 4 to 7.

An access point optimizes its channel selection by setting up a database concerning the occupancy of all of the available channels. In FIG. 4, the channels of the transmission band are represented by cones and the solid portions represent the occupancy percentages of the channels.

If there are enough free channels for the bandwidth requirements of the access point AP (i.e. channels not occupied by neighbors AP1-AP7, and regardless of transmission mode: 20 MHz, 40 MHz, 80 MHz, 80+80 MHz, 160 MHz), then the access point AP occupies the free channels. By way of example, and as shown in FIG. 5, the access point AP needs a bandwidth of 40 MHz, and it occupies the 40 MHz that are available and surrounded by a rectangle in the figure.

If enough free channels do not exist, then the access point AP is in a co-channel situation with neighboring access points as shown in FIG. 6. The access point AP selects on a priority basis those channels that generate little or no interference, i.e. channels belonging to a BSS that is remote but nevertheless detected in the signaling band. This information may be derived in particular from the localization information transmitted in the signaling band, from the reception power received and broadcast in the signaling band, from the load information of the APs as broadcast in the signaling band, or from a specific scan in the main channel occupied by the access point AP. For example, and as shown in FIG. 6, the access point AP requires 80 MHz of bandwidth. Since 80 MHz of contiguous bandwidth is not available, the access point AP in a first implementation puts itself into a co-channel situation with the neighboring access point AP2, the channels in question being surrounded by a rectangle in the figure.

A different implementation is described below. Returning to the present example of the access point AP requiring 80 MHz of bandwidth, turns out that enough free channels do indeed exist for the requirements of the access point, but that these channels are disjoint. The pertinent information relating to occupancy and available to the access point AP indicates that two adjacent channels representing 40 MHz are free, that three adjacent channels representing 60 MHz are free, and that these two groups are separated by a channel that is occupied by the access point AP2.

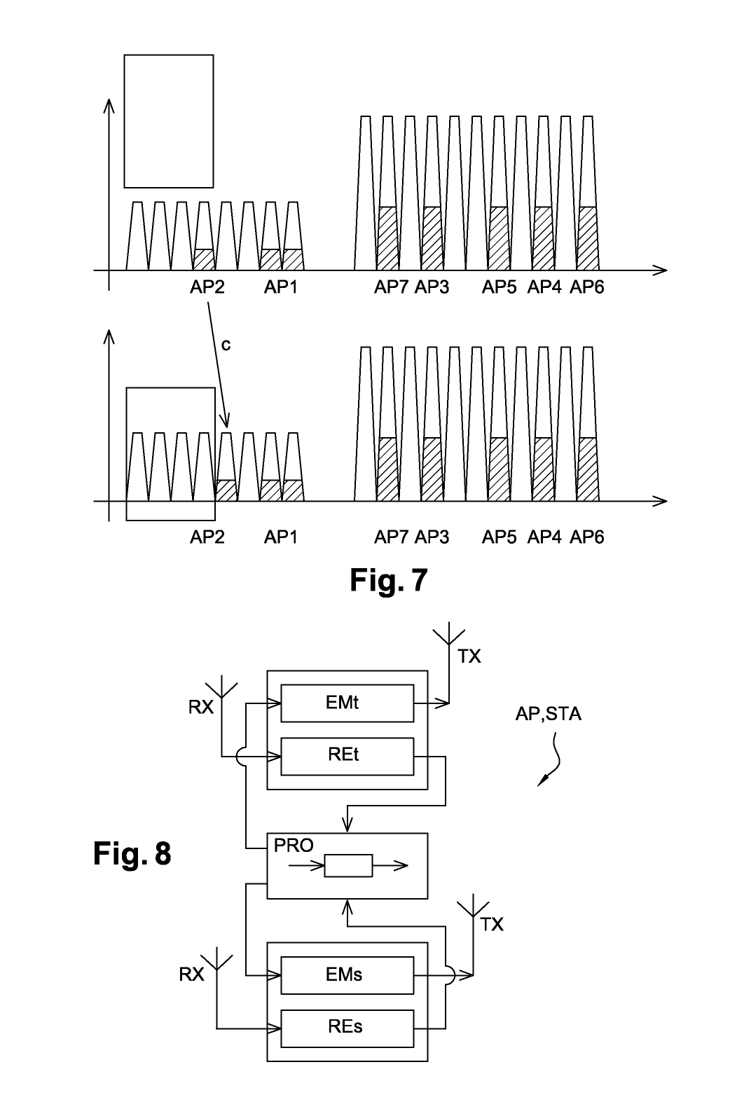

In this implementation, the access point AP launches a negotiation procedure shown in FIG. 7 to negotiate with the access point AP2 for it to switch channel c and release the channel it is occupying that is adjacent to the group of three free channels.

The negotiation is carried out by exchanging frames between the access points in the signaling band. The access point AP transmits a channel switch request and the access point AP2 responds with a channel switch response.

If the access point AP2 accepts, it switches channel and the access point AP occupies the channel that has been released together with the three adjacent channels, the channels in question being surrounded by a rectangle in FIG. 7.

The invention is described above for implementation with one access point. In similar manner, the method may be implemented by a station acting in particular in a mesh network, typically with peer-to-peer operation.

FIG. 8 is a diagram of a simplified structure example for a multiband WiFi device, AP or STA, suitable for performing a channel selection method of the invention. The WiFi device is intended in particular for a multiband WiFi access network having a plurality of multiband access points, a first band being said to be a “transmission” band, and a second band being said to be a “signaling” band and having coverage that is greater than the transmission band.

The WiFi device AP, STA comprises:
transceiver means EMt, REt for transmitting and receiving data frames via a channel of the transmission band. These means comprise a transmission system EMt and a reception system REt that are conventional and that present frequency characteristics that correspond to the transmission band;
transceiver means EMs, REs, suitable for transmitting and receiving signaling frames in the signaling band, the frames including pertinent information relating to the occupancy of the transmission band respectively by the access point and by neighboring access points. These means have a transmission system EMs and a reception system REs that are conventional and that present frequency characteristics that correspond to the signaling band and to transmitting and receiving the pertinent information.

The respective transceiver means EMt, REt, EMs, REs for the transmission and signaling bands are jointly adapted to be suitable for transmitting and receiving simultaneously. Typically, these transceiver means have rejection filters for very strongly attenuating the signals of one of the bands relative to the other band.

These transceiver means are typically coupled to calculator means PRO, e.g. a microprocessor or a digital signal processor (DSP), which means are microprogrammed to make up a frame of the pertinent information for transmission, and to make use of the pertinent information received from the neighboring access points. The calculation means may also be microprogrammed to launch a negotiation procedure with a neighboring access point to cause it to switch channel and release a channel that is adjacent to a free channel.

1. A method comprising:
selecting a channel for a multiband WiFi device in a WiFi network with multiband channel sharing between devices of the WiFi network, a first band being a “transmission” band, and a second band being a “signaling” band and having radio coverage that is greater than the transmission band, wherein selecting comprises:
transmitting first pertinent information in the signaling band, the information relating to occupancy of the transmission band by the device; and
receiving second pertinent information in the signaling band, the information relating to occupancy of the transmission band by neighboring devices, these steps taking place simultaneously with any step of transmission in the transmission band.

2. The method according to claim 1, wherein the first pertinent information is transmitted in a broadcast mode.

3. The method according to claim 1, wherein the first and second pertinent information is encapsulated in a frame having fields filled in for the purpose of transferring a session from a first channel to a second channel of the multiband WiFi network.

4. The method according to claim 1, the method further comprising:
exchanging frames in the signaling band between the device and a neighboring device, the device transmitting a channel switch request frame and waiting for a frame in response coming from the neighboring device indicating that the neighboring device accepts or rejects channel switching.

5. A multiband WiFi device for a multiband WiFi network having a plurality of multiband devices, a first band being a “transmission” band, and a second band being a “signaling” band and having radio coverage that is greater than the transmission band, the device being configured for performing a channel selection method, and comprising:
first transceiver means for transmitting and receiving data frames via a multiband channel of the transmission band;
second transceiver means for transmitting and receiving signaling frames in the signaling band, the signaling frames including pertinent information about occupancy of the transmission band respectively by the device and by neighboring devices; and
the first and second transceiver means being jointly configured for transmitting and receiving simultaneously.

6. The Multiband WiFi device according to claim 5, wherein:
the second transceiver means in the signaling band comprise broadcast means.

7. (canceled)

8. A non-transitory data medium including program instructions adapted to perform a method for selecting a channel for a multiband device in a WiFi network with multiband channel sharing between devices of the WiFi network, when said program is loaded in and executed by a device for performing the channel selection method, wherein a first band is of the multiband channel is a “transmission” band, and a second band is a “signaling” band having radio coverage that is greater than the transmission band, wherein the method comprises the following acts executed by the device:
transmitting first pertinent information in the signaling band, the information relating to occupancy of the transmission band by the device; and
receiving second pertinent information in the signaling band, the information relating to occupancy of the transmission band by neighboring devices, these steps taking place simultaneously with any step of transmission in the transmission band.
